(19) United States
(12) Patent Application Publication
(10) Pub. No.: US 2022/0067428 A1
(43) Pub. Date: Mar. 3, 2022

(54) SYSTEM FOR SELECTING LEARNING MODEL

(71) Applicant: Hitachi, Ltd., Tokyo (JP)

(72) Inventors: Charles LIMASANCHES, Tokyo (JP); Yuichi NONAKA, Tokyo (JP); Takashi KANEMARU, Tokyo (JP); Yuto KOMATSU, Tokyo (JP)

(21) Appl. No.: 17/406,494

(22) Filed: Aug. 19, 2021

(30) Foreign Application Priority Data
Aug. 26, 2020 (JP) 2020-142194

(51) Int. Cl. G06K 9/62; G06N 20/00

(52) U.S. Cl. CPC G06K 9/6227; G06N 20/00; G06K 9/6232; G06K 9/6202

(57) ABSTRACT

A learning model to be used for a new task is selected from among trained learning models. A processor acquires information on a detail of a new task and extracts a new characteristic amount vector from a new training data set for the new task. The processor references stored related information on a plurality of existing learning models and acquires information on details of tasks of the plurality of existing learning models and characteristic amount vectors of training data for the plurality of existing learning models. The processor selects a candidate learning model for the new task from among the plurality of existing learning models based on a result of comparing information on the detail of the new task with the tasks of the plurality of existing learning models and a result of comparing the new characteristic amount vector with characteristic amount vectors of the plurality of existing learning models.

### CLAIM OF PRIORITY

The present application claims priority from Japanese patent application JP 2020-142194 filed on Aug. 26, 2020, the content of which is hereby incorporated by reference into this application.

### BACKGROUND

The present invention relates to a system for selecting a learning model.

For companies that carry out “long-tail business activities” (business activities for which there are many customers but only a small amount of data is available for each customer), it is beneficial to use a previously developed deep learning model for new customers. For example, United States Patent Application No. 2018/0307978 discloses a method for generating a deep learning network model. This method extracts one or more items related to the generation of a deep learning network from multi-modal input from a user and estimates details caused by a deep learning network model based on the items. The method generates an intermediate expression based on the deep learning network model, and the intermediate expression includes one or more items related to the deep learning network model and one or more design details caused by the deep learning network model. The method automatically converts the intermediate expression into a source code.

### SUMMARY

However, it is difficult to use the previously developed deep learning model for new customers for some reasons. The reasons are a domain gap between data sets of customers, a difference between deep learning frameworks, a difference between tasks, and the like. In addition, it is difficult to evaluate one customer's data set and use additional data to reinforce the data set. Therefore, in the previous approach, data of new customers is sufficiently collected or a new model is built from scratch using a small amount of data. The former has a problem that the execution of learning is delayed due to the collection. The latter has a problem that performance may not be sufficient. In addition, when the previously built model is used, large efforts are required to understand the implementation.

According to an aspect of the present invention, a system selects a learning model for a user task. The system includes one or more processor and one or more storage devices. The one or more storage devices store related information on a plurality of existing learning models. The one or more processors acquire information on a detail of a new task, extract a new characteristic amount vector from a new training data set for the new task, reference the related information, acquire information on details of tasks of the plurality of existing models and characteristic amount vectors of training data for the plurality of existing models, and select a candidate learning model for the new task from among the plurality of existing models based on a result of comparing the information on the detail of the new task with information on the tasks of the plurality of existing models and a result of comparing the new characteristic amount vector with the characteristic amount vectors of the existing models.

According to the aspect of the present invention, an appropriate learning model to be used for a new task can be selected from among trained learning models.

### BRIEF DESCRIPTION OF THE DRAWINGS

FIG. 1A schematically illustrates a logical configuration of a model generation system according to an embodiment of the present specification.

FIG. 1B illustrates an example of a hardware configuration of the model generation system according to the embodiment of the present specification.

FIG. 2 illustrates an example of a whole operation of the model generation system according to the embodiment of the present specification.

FIG. 3 illustrates an example of processes to be executed by a task analyzer, an essential characteristic amount extractor, a database comparator, and a model selector according to the embodiment of the present specification.

FIG. 4 illustrates an example of a process to be executed by a data set evaluator according to the embodiment of the present specification.

FIG. 5 illustrates an example of a configuration of data stored in a model database according to the embodiment of the present specification.

FIG. 6 schematically illustrates an example of processes to be executed by a user interface for selection of a learning model and to be executed by the model generation system for data of the user interface.

FIG. 7 schematically illustrates an example of a user interface image for addition of new data to a user data set.

FIG. 8 schematically illustrates an initialization phase according to the embodiment of the present specification.

### DETAILED DESCRIPTION

The following description is divided into multiple sections or embodiments when it is necessary for convenience, but unless otherwise specified, they are not unrelated to each other and each of them has relationships of modifications, details, supplementary explanations, and the like of a part or all of the others. When the number of elements and the like (including the number of components, a value, an amount, a range, and the like) are described below, they are not limited to specific numbers unless otherwise specified and when they are clearly limited to specific numbers in principle, and they may be equal to or larger than specific numbers or may be equal to or smaller than specific numbers.

A system disclosed herein may be a physical computer system (one or more physical computers) or may be a system built on a computation resource group (a plurality of computation resources) such as a cloud platform. The computer system or the computation resource group includes one or more interface devices (including, for example, a communication device and an input/output device), one or more storage devices (including, for example, a memory (main storage device) and an auxiliary storage device), and one or more processors.

When a program is executed by the one or more processors to achieve a function, a defined process is executed using the one or more storage devices and/or the one or more interface devices and the like, and thus the function may serve as at least a portion of the one or more processors. A process that is described using the function as a subject may be a process to be executed by the one or more processors or the system including the one or more processors. The program may be installed from a program source. The program source may be, for example, a program distribution computer or a computer-readable storage medium (for example, a non-transitory computer-readable storage medium). The following description of each function is an example. A plurality of functions may be united into a single function. A single function may be divided into a plurality of functions.

The system proposed below is simplified by automatically selecting an appropriate previously built learning model based on a database and a description of a task desired by a user to be executed. The type of the existing learning model is arbitrary. The existing learning model is, for example, a deep learning model. In the following description, a learning model is also referred to as model.

### Overview

In an embodiment, a user inputs, to the system, a simple description of a task (new task) desired by the user to be executed and a training data set for the task. The system extracts an essential characteristic amount from the training data set and extracts related information on the task from the description of the task. The system uses a model, data used for training of the model, the corresponding essential characteristic amount, and the description of the corresponding task to find a related learning model in a database storing the foregoing information. The learning model selected from the database is finely adjusted (retrained) using a user's data set. This enables the model to be adapted to a different user's data set.

In another aspect, in addition to the foregoing configuration, the user's training data set is evaluated and the ratio of a sample harmful to the model to the training data set is calculated. The harmful sample is a sample harmful to training of the learning model and is, for example, an outlier caused by erroneous labeling or collection of low-quality data. Based on the ratio of the harmful sample to the training data set, the system can reinforce the user's training data set using new data acquired from an existing database or the Internet. This can improve the performance of the learning model for the user.

To find appropriate data in order to add the data to training data, the system analyzes a task description given by the user. The new data is reevaluated and guaranteed not to be harmful to the model. The new data is collected until the ratio of harmful data becomes smaller than a threshold and the maximum performance of the learning model can be guaranteed. Lastly, the learning model is trained (finely adjusted) using the user's training data set.

In another aspect, in addition to the foregoing configuration, the finely adjusted learning model is stored in the database together with the training data set, the extracted essential characteristic amount, and the task description and can be used for future use of the system.

The system disclosed below enables the user to easily find a learning model optimal for the task. The system does not require the user to configure the learning model for the task from scratch and can save user's time. The system can be adapted to different data and enables the same learning model to be used for various users and various tasks. In addition, the system can evaluate the user's training data set, add new data when necessary, and improve the performance of the learning model.

The system according to the embodiment of the present specification includes a task analyzer and an essential characteristic amount extractor. Input to the task analyzer is a description input by a user. Details of a task desired by the user to be achieved are briefly described. Output from the task analyzer is a task expression in a format that enables a next functional section to acquire an optimal learning model. As an example, the task expression can be in the format of a keyword string or a character string. The task description input by the user and the task expression generated from the task description are information on the details of the task.

Input to the essential characteristic amount extractor is a user's training data set that includes a plurality of files and is in a folder format. Each of the files is one sample of the training data set. Output from the essential characteristic amount extractor is one-dimensional characteristic amount vectors corresponding to data samples included in the user's training data set. Each of the one-dimensional characteristic amount vectors can include a plurality of elements.

The essential characteristic amount extractor can use an auto-encoder neural network, for example. The network reduces the number of dimensions of the input while processing the input by continuous neuron layers. As an example, this technique can be used to reduce a two-dimensional image to a one-dimensional vector.

Architecture of an auto-encoder is configured to have a disentanglement feature and can separate a user-specific characteristic amount and an essential characteristic amount from each other. “Disentangled” indicates a disentangled state. Disentangled expression learning is a known technique. The architecture with the disentanglement feature can capture characteristic amounts independent of each other and generates a characteristic amount for each element in input data in a latent space. An essential characteristic amount vector is a vector composed of characteristic amounts important to solve a user task by the system. A method for determining an essential characteristic amount vector is described later in detail.

Output from both functional sections is used as input to a database comparator. The database comparator compares a task expression extracted from a user description with another task expression within the database. As an example, when the task expression is in a character string format, the most similar string can be acquired using a classical metric distance such as a Levenshtein distance. As another example, when the task expression is a keyword string, a general document comparison method for comparing appearance frequencies of words as vectors may be used. The database may store a task expression of an existing model and the task expression may be generated from a user's description for the task.

The database comparator compares an essential characteristic amount vector with another essential characteristic amount vector within the database. The comparison can be achieved using, for example, a classical metric distance such as a Euclidean distance. The database may store an essential characteristic amount vector of an existing model, and the essential characteristic amount vector may be generated for comparison from training data for the existing model within the database.

A learning model optimal for a user task can be selected by using a result of task comparison and a result of vector comparison. Therefore, the user can reuse an appropriate existing learning model for a new task. Due to extraction of an essential characteristic amount, the selected learning model can exhibit excellent performance even when the learning model is trained using data different from the user's training data set. When the optimal learning model is selected, the selected learning model is trained (finely adjusted) using the user's data set.

In at least one embodiment, in addition to the foregoing constituent elements, a module that can evaluate the user's training data set and calculate a ratio of a sample harmful to a model can be included. The harmful sample is a sample that is included in the training data set and reduces the performance of the model. The data may be an outlier caused by erroneous labeling or a low-quality data sample. The data is checked and a specific modification (deletion of the sample, relabeling, or the like) is made on the data.

Input to a data evaluator is a learning model selected by a model selector and the user's training set. The data evaluator outputs a ratio of harmful data to the training data set. The data evaluator can be based on a known influence function technique. This technique evaluates an influence rate of each data sample on the performance of the model. It is possible to determine, based on the influence rates, whether the samples are harmful.

When the ratio of harmful data exceeds a predetermined threshold, the system uses data from an existing database or an open network to reinforce the data set (or add a new data sample). The reinforcement of the data set is executed by analyzing a task (description about the task) given by the user. The new data is reevaluated by the data evaluator. Whether the new data is harmful is checked. Then, the new data is added to initial data. This functional section is useful for a small amount of data or a training data set including a large amount of noise (data of an erroneous label).

In at least one example, in addition to the foregoing elements, a module that can store a newly trained learning model can be included. The learning model is automatically formatted in such a manner that the learning model can be used by the system in the future. The module can store an essential characteristic amount vector of the user's training data set, a task description input by the user, and an extracted task expression in association with the learning model. The module may store the user's training data set.

### Specific Configuration

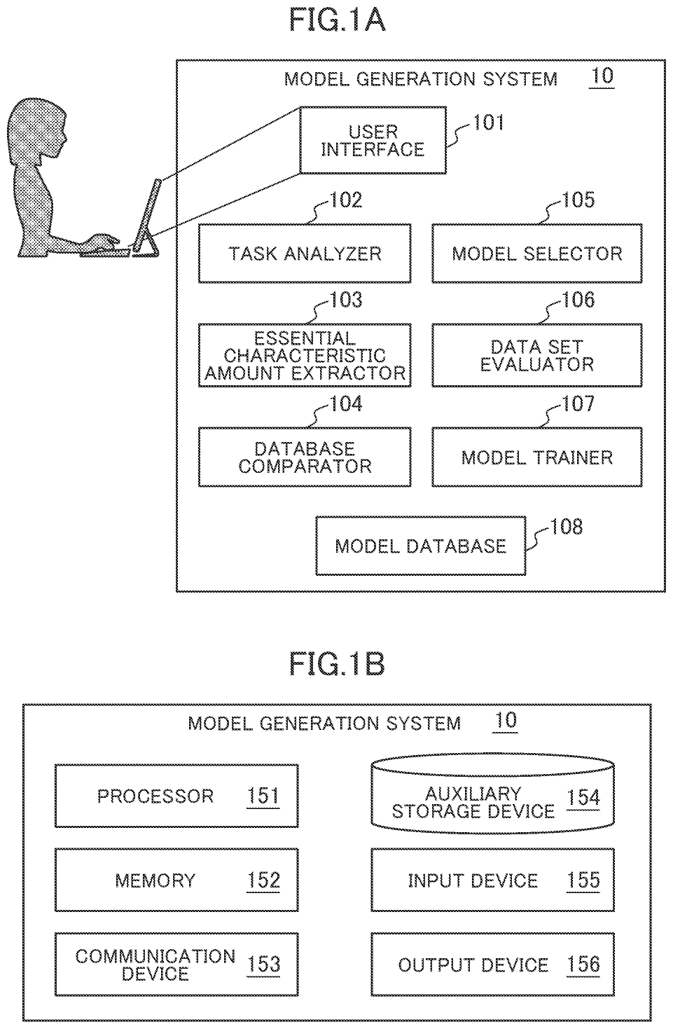

An example of the embodiment of the present specification is described in detail with reference to the drawings. FIG. 1A schematically illustrates a logical configuration of a model generation system 10 according to the embodiment of the present specification. The model generation system 10 includes a user interface 101, a task analyzer 102, an essential characteristic amount extractor 103, a database comparator 104, a model selector 105, a data set evaluator 106, a model trainer 107, and a model database (model storage section) 108.

The user interface 101 generates an image for inputting data by a user, displays the generated image on an output device, and receives data input by the user via an input device. The task analyzer 102 extracts, from a task description input by the user, a task expression for selection of a learning model. The essential characteristic amount extractor 103 extracts an essential characteristic amount vector from a training data set for a user task.

The database comparator 104 compares information on learning models stored in the database with the task expression of the user task and the essential characteristic amount vector. The model selector 105 selects a learning model appropriate for the user task. The data set evaluator 106 detects harmful data in the user's training data set.

The model trainer 107 trains the selected existing learning model using the user's training data set. The model database 108 stores the existing model, related information on the existing model, the newly trained learning model, and related information on the newly trained learning model. As described later, the related information includes a task description of the learning model and an essential characteristic amount vector of training data.

FIG. 1B illustrates an example of a hardware configuration of the model generation system 10. The model generation system 10 includes a processor 151 with calculation performance and a memory 152 that provides a volatile temporary storage region that stores a program to be executed by the processor 151 and data. The model generation system 10 further includes a communication device 153 that communicates data with another device, and an auxiliary storage device 154 that uses a hard disk drive, a flash memory, or the like to give a permanent information storage region. The memory 152 that is a main storage device, the auxiliary storage device 154, and a combination thereof are examples of a storage device.

The model generation system 10 includes an input device 155 that receives an operation from the user, and an output device 156 that presents an output result of each process to the user. The input device 155 includes, for example, a keyboard, a mouse, a touch panel, and the like. The output device 156 includes, for example, a monitor and a printer.

The functional sections 101 to 107 illustrated in FIG. 1A can be achieved by causing the processor 151 to execute a corresponding program stored in the memory 152. The model database 108 can be stored in, for example, the auxiliary storage device 154. The model generation system 10 may be constituted by a single computer or a plurality of computers that can communicate with each other.

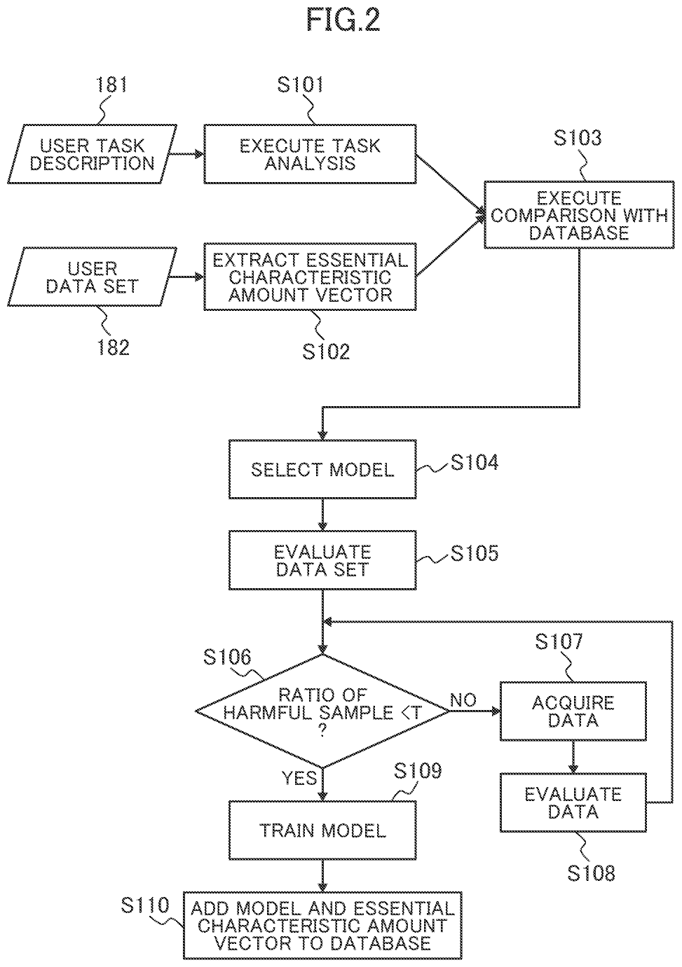

FIG. 2 illustrates an example of a whole operation of the model generation system 10 according to the embodiment of the present specification. The model generation system 10 has two input sections. One of the input sections is a simple description 181 of a user task in a sentence format or a text format and the other is a user's training data set 182 (user data set) in a file folder format. Each file is sample data. The sample data includes a label and data (input data) to be processed for a task.

The task analyzer 102 analyzes the user task description 181 and extracts useful information such as a keyword from the user task description (S101). The user data set 182 is input to the essential characteristic amount extractor 103. The essential characteristic amount extractor 103 extracts an essential characteristic amount vector from the user data set 182 (S102).

Output from the essential characteristic amount extractor 103 and output from the task analyzer 102 are input to the database comparator 104. The database comparator 104 compares the essential characteristic amount vector from the user data set 182 and a task expression with essential characteristic amount vectors of existing models and task expressions within the model database 108 and outputs a result of the comparison (S103). The model selector 105 selects an existing learning model optimal for the user task based on the result of the comparison by the database comparator 104 (S104). The selected learning model and the user data set 182 are input to the data set evaluator 106.

The data set evaluator 106 processes each sample of the user data set 182 and evaluates whether each sample is harmful to the selected model (S105). As described later, an influence function can be used to evaluate each sample, for example. A harmful sample is a sample that reduces the performance of the model due to training and may be caused by, for example, erroneous labeling or low-quality data.

After all samples are processed, the data set evaluator 106 calculates a ratio of a harmful sample to the data set. The model generation system 10 selects one of two operations based on the ratio (S106).

When the ratio of the harmful data is equal to or larger than a threshold (NO in step S106), the data set evaluator 106 acquires new data stored in the model database 108 or acquires new data from another database (for example, a database on the Internet) (S107). The threshold may be set to a fixed value of 30% or the user may specify, as the threshold, a value that can be considered to enable the performance of the learning model to be guaranteed.

The data set evaluator 106 searches for data on the task description of the user task or data close to the essential characteristic amount vector, for example. Alternatively, when sufficient data cannot be acquired from a result of the search, the data set evaluator 106 acquires such data from another database. The data set evaluator 106 uses an influence function or the like to evaluate the newly acquired data and checks whether the newly acquired data is harmful. When the data set evaluator 106 determines that the newly acquired data is not harmful, the data set evaluator 106 adds the newly acquired data to initial data (S108). The acquisition of new data is repeated until a ratio of a harmful sample becomes smaller than the threshold.

An effect of automatically reinforcing data effective for learning for a training data set including a small amount of data or a large amount of noise (data with an erroneous label) and improving the performance of the learning can be obtained. In this case, the data set evaluator 106 may execute processing to remove harmful data from the training data set. The processes of S107 and S108 may be repeated for each sample or may be collectively executed on, for example, the number of samples determined to be harmful in S105.

When the ratio of the harmful sample is smaller than the threshold (YES in step S106), the model trainer 107 trains the selected learning model using the user data set (S109). Input to the learning model for the training is the essential characteristic amount vector extracted from the user data set. After that, the trained learning model, the essential characteristic amount vector of the training data, and the task description are stored in the model database 108 and can be used for the future (S110).

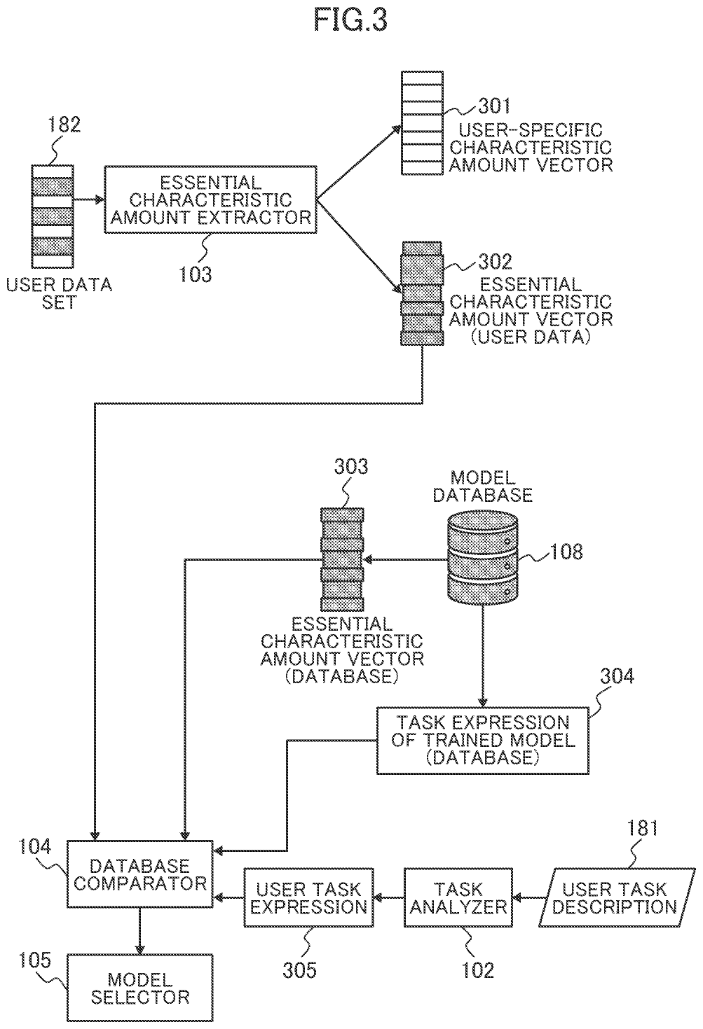

FIG. 3 illustrates an example of processes to be executed by the task analyzer 102, the essential characteristic amount extractor 103, the database comparator 104, and the model selector 105. The essential characteristic amount extractor 103 uses an auto encoder to extract an essential characteristic amount vector. The auto encoder is a neural network. The auto encoder processes input via a plurality of neuron layers and reduces the number of dimensions of the input (sample of the user data set 182).

In the present embodiment, the auto encoder has a disentanglement feature and can generate two vectors. One of the vectors is a user-specific characteristic amount vector 301 composed of user-specific characteristic amounts, while the other vector is an essential characteristic amount vector 302 composed of essential characteristic amounts. The essential characteristic amount vector 302 is a vector including only characteristic amounts useful for a user task. The essential characteristic amount vector 302 is input to the database comparator 104.

The database comparator 104 uses, for example, a classical vector distance such as a Euclidean distance to compare the essential characteristic amount vector 302 of the user with another vector stored in the model database 108. The database comparator 104 compares a plurality of essential characteristic amount vectors 302 with essential characteristic amounts of existing learning models (trained learning models) stored in the model database 108. For example, the database comparator 104 calculates a predetermined statistical value of distances between the essential characteristic amount vectors of the user data set and the essential characteristic amount vectors of the existing models or calculates, for example, an average value of the distances. This calculated value is output as a result of the comparison of the existing models with the user data set.

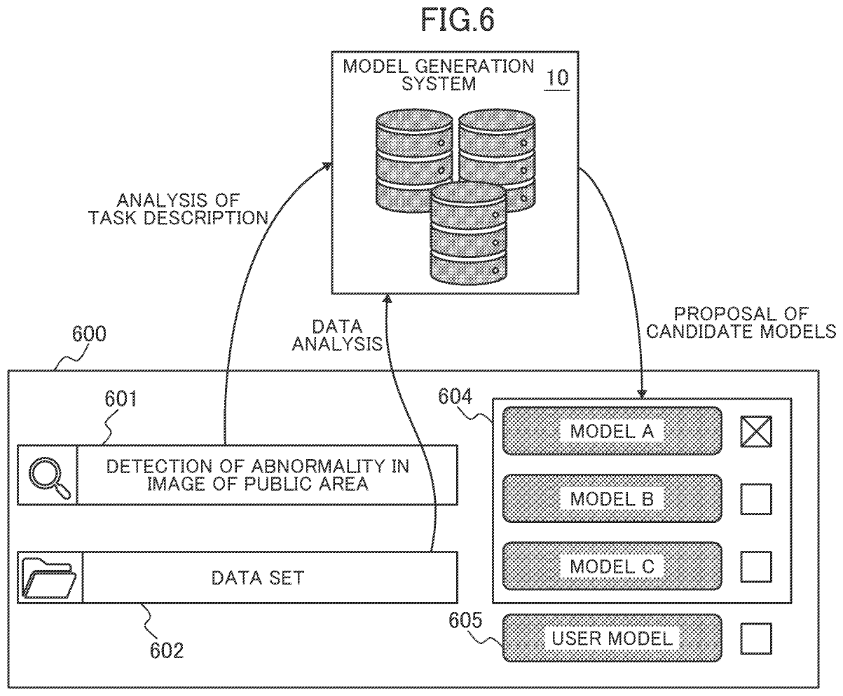

The task analyzer 102 generates a user task expression 305 from the task description 181 of the user. As described above, the task expression is, for example, a character string and can be in a string vector format. Specifically, each row of the vector is each character of the task description. From a task description “Detection of abnormality in image of public area” illustrated in FIG. 6, a 48×1 matrix vector ““D” “e” “t” “e” “c” “t” “i” “o” “n” “ ” “o” “f” “a” “b” . . . “a” “r” “e” “a”” is generated.

The database comparator 104 compares the user task expression 305 generated by the task analyzer 102 with task expressions of the existing learning models stored in the model database 108. The comparison of the task expressions can be executed using a method for measuring a classical text distance such as a Levenshtein distance. The calculated distance is output as a result of the comparison between tasks of the existing learning models and the user task. Another example of comparing user task expression 305 is with generating an 8×1 matrix vector ““Detection” “of” “abnormality” . . . “area”” from a task description, and applying some known morphological analysis.

The model selector 105 selects one or multiple appropriate candidates from the existing learning models stored in the model database 108 based on the result, calculated by the database comparator 104, of comparing the essential characteristic amount vectors and the result, calculated by the database comparator 104, of comparing the task expressions. For example, the model selector 105 calculates similarity scores by inputting the result of comparing the task expressions and the result of comparing the essential characteristic amount vectors to a predetermined function. The model selector 105 selects one or multiple existing learning models as the one or more candidates in the order from the highest similarity score.

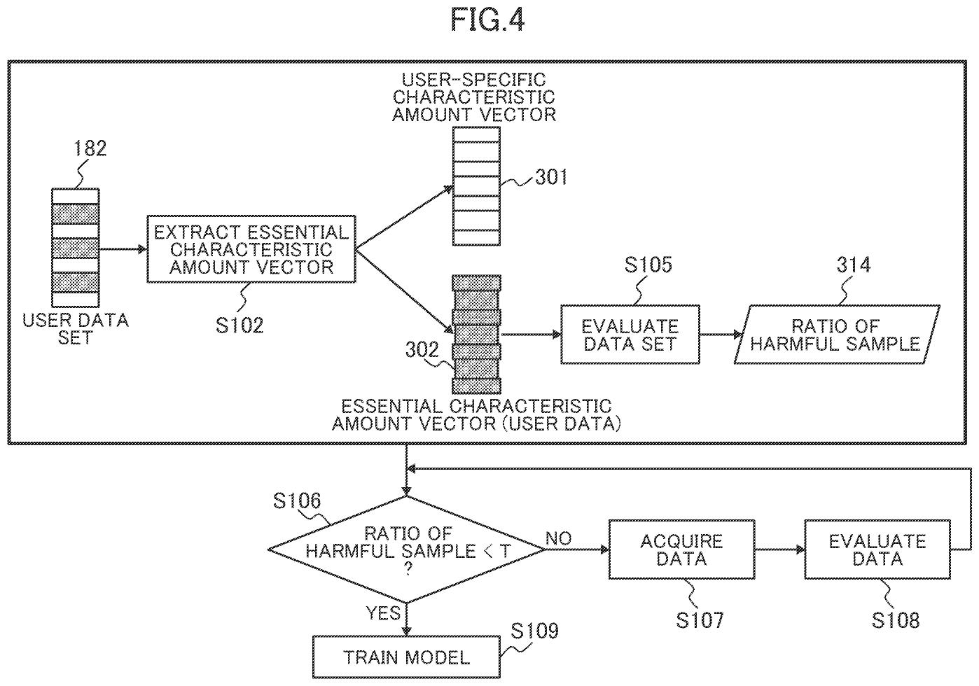

FIG. 4 illustrates an example of a process to be executed by the data set evaluator 106 according to the embodiment of the present specification. To simplify understanding, FIG. 4 illustrates a process to be executed by the essential characteristic amount extractor 103 to generate the user data set 182, the user-specific characteristic amount vector 301, and the essential characteristic amount vector 302, and a process to be executed by the model trainer 107.

When a learning model selected from the model database 108 and the essential characteristic amount vector 302 generated by the essential characteristic amount extractor 103 are given, the data set evaluator 106 evaluates the user data set 182 (S105). The data set evaluator 106 uses, for example, the influence function technique to calculate an influence rate of an essential characteristic amount of each sample of the user data set 182 on the performance of the selected learning model. The influence function is used to calculate an influence rate of an essential characteristic amount of each sample on inference by the learning model in training. By referencing the influence rate, a harmful sample or an outlier caused by erroneous labeling or low-quality data can be detected in the data set.

The data set evaluator 106 calculates a ratio 314 of a harmful sample to the user data set 182. When the ratio 314 of the harmful sample is equal to or larger than the threshold (NO in S106), the data set evaluator 106 acquires new data (S107). The data set evaluator 106 acquires the data from an existing database or collects the data from the Internet. These processes are described above.

The data set evaluator 106 evaluates the newly acquired data (S108). S107 and S108 are repeated until the ratio of the harmful sample becomes smaller than the threshold T. When this condition is satisfied, the model trainer 107 trains (finely adjusts) the selected learning model using the user data set 182 or a data set updated by adding the new data (S109).

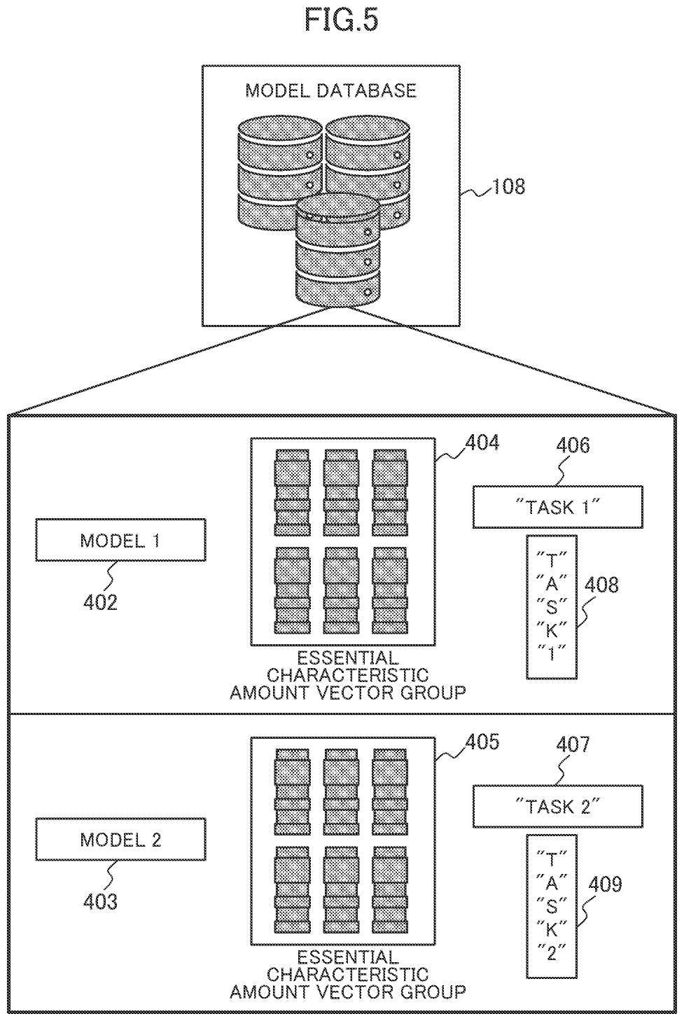

FIG. 5 illustrates an example of a configuration of data stored in the model database 108 according to the embodiment of the present specification. As an example, details of the model database 108 include two learning models 402 and 403 and related information on the learning models 402 and 403. Each of the learning models includes architecture of the learning model and a source code of the learning model. Essential characteristic amount vector groups 404 and 405 used to train the learning models 402 and 403 are included in the learning models 402 and 403, respectively. Task descriptions 406 and 407 in a text format are included in the learning models 402 and 403, respectively.

FIG. 5 simply illustrates a task 1 and a task 2. However, arbitrary texts specified by the user may be processed. Details entered in a field 601 for entering such a task description as illustrated in FIG. 6 correspond to an example. In addition, task expressions 408 and 409 are included. The task expressions may be generated by the task analyzer 102 upon data storage.

The learning models and the related information on the learning models may be stored in different databases. In addition, either the task descriptions or the task expressions may not be included. Only the task descriptions or the task expressions may be stored. When only the task descriptions are stored, the task analyzer 102 generates the task expressions from the task descriptions and outputs the task expressions to the database comparator 104. Furthermore, the number of essential characteristic amount vectors related to the learning models is equal to the number of data samples to be used to train the models.

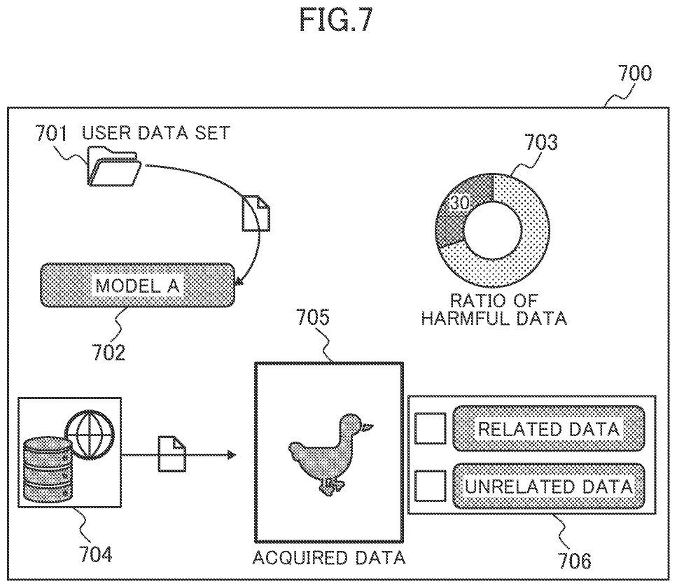

A user interface (UI) according to the embodiment of the present specification is described with reference to FIGS. 6 and 7. FIG. 6 schematically illustrates an example of the user interface for selection of a learning model. A user interface image 600 includes the field 601 for entering a task description by the user and a field 602 for entering a storage destination of a user data set that is training data.

The user uses a natural language to enter a simple task description in the field 601. The user enters information of a storage location of the data set in the field 602. In the example illustrated, the user desires to solve the task “detection of abnormality in image of public area”. The corresponding data set is a folder storing a plurality of images of the public area and labels (indicating that an abnormality is present or not present) associated with the images.

The data set and the task description are analyzed by the model generation system 10. The model generation system 10 outputs a list of candidates for an appropriate learning model by executing the foregoing processes on the given task. In the example illustrated in FIG. 6, the model generation system 10 presents three candidates, a model A, a model B, and a model C. The user interface image 600 displays the presented candidate learning models in a section 604. The user can select a learning model to be actually used from among the presented candidate models. The user can freely select a learning model prepared by the user and displayed in a section 605.

FIG. 7 schematically illustrates an example of a user interface image to be used to add new data to a user data set. A user interface image 700 indicates processing by a learning model A702 on a user data set 701. A processing result 703 indicates a ratio of a sample that is harmful to the selected learning model A and included in the user data set.

Based on the ratio, the model generation system 10 determines whether to reinforce the user data set using new data acquired from an existing database or the Internet. When the user data set is to be reinforced, the user interface image 700 indicates, for example, an image 704 indicating a source of a new sample and a newly acquired sample 705.

The user can confirm the new sample 705, determine whether the sample is related to a user's task, and enter the result of the determination in a field 706. The model generation system 10 evaluates the new sample specified by the user as being related to the task. When the new sample is not a harmful sample, the model generation system 10 adds the new sample to the user data set. Therefore, it is possible to secure training data with which a selected learning model can be appropriately trained.

The sample evaluation is executed by calculating an essential characteristic amount of the new sample by the essential characteristic amount extractor 103 and using, for example, an influence function to calculate an influence rate of the essential characteristic amount on the performance of a learning model. Although FIG. 7 illustrates the example of presenting and processing a single sample, a plurality of samples may be simultaneously presented and processed.

As described above, the model generation system 10 selects a candidate learning model for a new task from trained learning models stored in the model database 108. The following describes a process (initialization phase) of storing, in the model database 108, a trained learning model and an essential characteristic amount vector associated with the trained learning model before selection of a learning model.

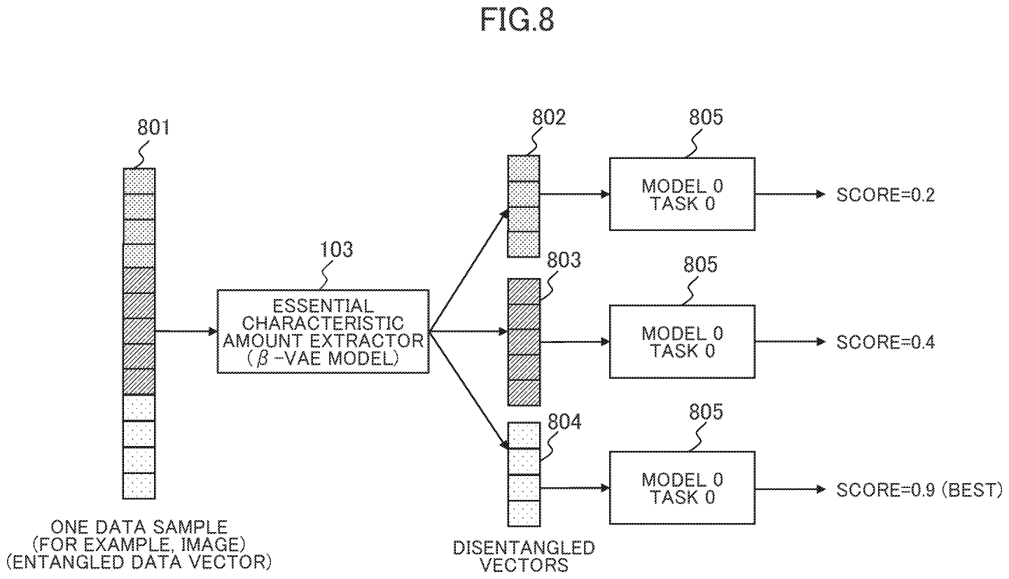

FIG. 8 schematically illustrates the initialization phase according to the embodiment of the present specification. The essential characteristic amount extractor 103 can use a β-VAE deep learning model, for example. This model has a feature of disentangling characteristic amounts. The essential characteristic amount extractor 103 separates different characteristic amounts of data of an entangled data vector 801 into different vectors 802, 803, and 804. For example, the essential characteristic amount extractor 103 outputs, from an image (entangled expression), some vectors indicating different characteristic amounts (a state of light, a camera angle, the number of persons in the image, and the like).

The essential characteristic amount extractor 103 generates the different vectors 802, 803, and 804 corresponding to the different characteristic amounts. The characteristic amount vectors are used as input to a learning model. In this case, the learning model is the first model of the database and is referred to as model 0. The essential characteristic amount extractor 103 executes a task 0 by the model 0 for the characteristic amount vectors (805) and calculates scores for the characteristic amount vectors of various types. For example, when the task 0 is a classification task and the model 0 is a classification model, the scores indicate the accuracy of classification.

A characteristic amount vector that gives the best score can be considered to be an essential characteristic amount vector. As an example, the characteristic amount vector 804 gives the best score (0.9 in FIG. 8) to sample data of a data set and can be considered to be an essential characteristic amount vector. The essential characteristic amount vector, the learning model (model 0), and a description of the task (task 0) are stored in the model database 108.

After the execution of the initialization, the model generation system 10 can be used by a new user. The essential characteristic amount extractor 103 disentangles a data set 182 of the new user. A disentangled characteristic amount vector is compared with an essential characteristic amount vector in the model database 108.

A user's characteristic amount vector that is the most similar to the essential characteristic amount in the model database 108 is considered to be an essential characteristic amount vector of the user. Other characteristic amount vectors are considered to be user-specific characteristic amount vectors. In this manner, the essential characteristic amount vector of the user can be appropriately determined based on results of comparing multiple user characteristic amount vectors with essential characteristic amount vectors of existing learning models.

As similarities, classical metric distances such as Euclidean distances can be used. For example, the database comparator 104 calculates a predetermined statistical value (for example, an average value) of similarities between various characteristic amount vectors of a user data set and characteristic amount vectors within the model database 108 and determines, as an essential characteristic amount vector, a characteristic amount vector of a type indicating that a value of the characteristic amount value is the most similar (shortest distance). Remaining processes are described above with reference to FIGS. 2, 3, and 4.

The present invention is not limited to the foregoing embodiment and includes various modifications. For example, the embodiment is described above in detail in order to clearly explain the present invention and may not be necessarily limited to all the configurations described above. A part of a configuration described in a certain embodiment can be replaced with a configuration described in another embodiment. A configuration described in a certain embodiment can be added to a configuration described in another embodiment. A configuration can be added to, removed from, or replaced with a part of a configuration described in each embodiment.

The foregoing constituent, functional, and processing sections and the like may be achieved by hardware, for example, by designing integrated circuits or the like. The foregoing constituent, functional, and processing sections and the like may be achieved by software, for example, by causing a processor to interpret and execute a program that achieves the functions of the sections. Information of the program that achieves the functions, a table, a file, and the like can be stored in a storage device such as a memory, a hard disk, or a solid state drive (SSD), or a storage medium such as an IC card or an SD card.

Control lines and information lines that are considered to be necessary for the description are illustrated, and all control lines and information lines of a product may not be necessarily illustrated. In practice, it may be considered that almost all configurations are connected to each other.

What is claimed is:

1. A system that selects a learning model for a user task, the system comprising:
one or more processors; and
one or more storage devices, wherein
the one or more storage devices store related information on a plurality of existing learning models,
the one or more processors acquire information on a detail of a new task, extract a new characteristic amount vector from a new training data set for the new task, reference the related information, and acquire information on details of tasks of the plurality of existing learning models and characteristic amount vectors of training data for the plurality of existing learning models, and
the one or more processors select a candidate learning model for the new task from among the plurality of existing learning models based on a result of comparing the information on the detail of the new task with information on the tasks of the plurality of existing learning models, and a result of comparing the new characteristic amount vector with characteristic amount vectors of the plurality of existing learning models.

2. The system according to claim 1, wherein
the one or more processors determine whether a sample included in the new training data set is harmful to training of the candidate learning model.

3. The system according to claim 2, wherein
when an amount of a sample determined to be harmful is equal to or larger than a threshold, the one or more processors determine to add a new sample to the new training data set.

4. The system according to claim 3, wherein
the one or more processors search for a new sample to be added to the new training data set, based on information on the new task, and
the one or more processors determine whether the new sample is harmful to training of the candidate learning model.

5. The system according to claim 1, wherein
the one or more processors generate a plurality of characteristic amount vectors from the new training data set, and
the one or more processors determine the new characteristic amount vector from the plurality of characteristic amount vectors based on a result of comparing the plurality of characteristic amount vectors with the characteristic amount vectors of the plurality of existing learning models.

6. The system according to claim 1, wherein
the one or more processors use the new training data set to train the candidate learning model.

7. The system according to claim 6, wherein
the one or more processors associate the characteristic amount vector of the new training data set with information on the new task and cause the characteristic amount vector of the new training data set and the information on the new task to be stored in the one or more storage devices.

8. A method for selecting a learning model for a user task by a system, the method comprising:
causing the system to acquire information on a detail of a new task;
causing the system to extract a new characteristic amount vector from a new training data set for the new task;
causing the system to acquire information on details of tasks of a plurality of existing learning models, and characteristic amount vectors of training data for the plurality of existing learning models; and
causing the system to select a candidate learning model for the new task from among the plurality of existing learning models based on a result of comparing the information on the detail of the new task with information on the tasks of the plurality of existing learning models, and a result of comparing the new characteristic amount vector with characteristic amount vectors of the plurality of existing learning models.

9. The method according to claim 8, wherein
the system determines whether a sample included in the new training data set is harmful to training of the candidate learning model.

10. The method according to claim 9, wherein
when an amount of a sample determined to be harmful is equal to or larger than a threshold, the system determines to add a new sample to the new training data set.

11. The method according to claim 10, wherein
the system searches for a new sample to be added to the new training data set, based on information on the new task, and
the system determines whether the new sample is harmful to training of the candidate learning model.

12. The method according to claim 8, wherein
the system generates a plurality of characteristic amount vectors from the new training data set, and
the system determines the new characteristic amount vector from the plurality of characteristic amount vectors based on a result of comparing the plurality of characteristic amount vectors with the characteristic amount vectors of the plurality of existing learning models.

13. The method according to claim 8, wherein
the system uses the new training data set to train the candidate learning model.

14. The method according to claim 13, wherein
the system associates the characteristic amount vector of the new training data set with information on the new task and causes the characteristic amount vector of the new training data set and the information on the new task to be stored in a database.
